(19) United States
(12) Patent Application Publication
(10) Pub. No.: US 2026/0130379 A1
(43) Pub. Date: May 14, 2026

(54) KOREAN PANCAKE MIX COMPOSITION INCLUDING ASTER YOMENA AND MANUFACTURING METHOD THEREOF

(71) Applicant: Gurye Uncle Corp., Gurye-gun (KR)

(72) Inventor: Myung Yup LEE, Gurye-gun (KR)

(21) Appl. No.: 18/950,307

(22) Filed: Nov. 18, 2024

(30) Foreign Application Priority Data
Nov. 8, 2024 (KR) 10-2024-0157567

(51) Int. Cl. A21D 2/36; A21D 10/00; A23B 7/02; A23L 19/00; B65B 5/12; B65B 25/00

(52) U.S. Cl. CPC A21D 2/36; A21D 10/005; A23B 7/0215; A23L 19/01; B65B 5/12; B65B 25/001

(57) ABSTRACT

The present invention relates to a Korean pancake mix composition including Aster yomena and a manufacturing method thereof, and more specifically, to a Korean pancake mix composition including Aster yomena and a manufacturing method thereof, wherein the Korean pancake mix composition is manufactured through a vegetable preprocessing step of preprocessing various vegetables including Aster yomena; a vegetable mixture packaging step of mixing and packaging vegetables; a wheat flour packaging step of packaging wheat flour; and a Korean pancake mix composition manufacturing step of packaging the vegetable mixture and wheat flour to manufacture a Korean pancake mix composition, so the Korean pancake mix composition including Aster yomena and a manufacturing method thereof have the advantages that excellent sensory preferences such as taste, aroma, and flavor due to the unique savory and bittersweet taste of Aster yomena are provided; the vegetables are dried using near-infrared rays, so that the vegetables easily become soft without being soaked in water and the original color, taste, and aroma of raw vegetables may be preserved for a long time; the vegetables and wheat flour are enclosed together, it is not necessary to individually manufacture each ingredient for the Korean pancake; and vegetables that are not in season may be consumed all year round, thereby providing economic benefits and convenience.

### CROSS-REFERENCE TO RELATED APPLICATION

This patent application claims priority to Korean Patent Application No. 10-2024-0157567, filed Nov. 8, 2024 and the entire contents of which are incorporated herein by reference.

### BACKGROUND OF THE INVENTION

### Field of the Invention

The present invention relates to a Korean pancake mix composition including Aster yomena and a manufacturing method thereof, and more specifically, to a Korean pancake mix composition including Aster yomena and a manufacturing method thereof, wherein the Korean pancake mix composition is manufactured through a vegetable preprocessing step of preprocessing various vegetables including Aster yomena; a vegetable mixture packaging step of mixing and packaging vegetables; a wheat flour packaging step of packaging wheat flour; and a Korean pancake mix composition manufacturing step of packaging the vegetable mixture and wheat flour to manufacture a Korean pancake mix composition, so the Korean pancake mix composition including Aster yomena and a manufacturing method thereof have the advantages that excellent sensory preferences such as taste, aroma, and flavor due to the unique savory and bittersweet taste of Aster yomena are provided; the vegetables are dried using near-infrared rays, so that the vegetables easily become soft without being soaked in water and the original color, taste, and aroma of raw vegetables may be preserved for a long time; the vegetables and wheat flour are enclosed together, it is not necessary to individually manufacture each ingredient for the Korean pancake; and vegetables that are not in season may be consumed all year round, thereby providing economic benefits and convenience.

### Description of the Related Art

Korean pancake (Buchimgae) is a traditional Korean food made by various ingredients such as various vegetables, meat, seafood, and the like in oil, flattening them with wheat flour, starch, or rice powder, and frying them. The process of preparing the ingredients for this Korean pancake is quite complicated, as it is made by preparing each of the ingredients and preparing a batter according to the ingredients contained therein, and most of the preparation is done manually. Nowadays, with the increase in single-person households and the rise in food prices, it is not easy to make Korean pancake at home. Recently, with the development of convenience foods, various soups, stews, side dishes, and other dishes are sold in the form of meal kits, and the Korean pancake is marketed in semi-cooked forms such as meal kits and frozen foods so that it can be easy to make and eat at home.

Aster yomena, a representative mountain vegetable of the Asteraceae family in Korea, is a perennial herb widely distributed in Korea, China, Japan, and Siberia, and it grows with rhizomes extending sideways. Aster yomena grows well in slightly humid mountains and fields, and the main stem is reddish when it first emerges, but gradually turns purple on a green background. The leaves on the roots fall when the flowers bloom, and the leaves on the stem are alternate and lanceolate, and have serrated edges. The outer surface is green and glossy, and the size gets smaller as it goes up. The flowers bloom between July and October. Young shoots may be boiled and eaten as a seasoned vegetable or stir-fried in oil, and the leaves contain essential oils. Aster yomena has 43.0 kcal of calories, 84.2% of moisture, 4.35 g of protein, 0.9 g of lipid, 6.9 g of carbohydrate, 1.9 g of fiber, 1.8 mg of ash, 67 mg of phosphorus, 12.8 mg of iron, 710 mg of vitamin A, 0.04 mg of vitamin B, and 21.0 mg of vitamin C (Lee, Seong-Hee (2008), Development of cultivation technology for indigenous leafy vegetables as a new income crop in inland mountainous areas, Chungju Agricultural Technology Center, 9-16.). Aster yomena is rich in vitamin C and contains many other physiologically active ingredients (Kim D J, YUK C S (2001), Studies on the constituents of Kalimeris flowers. College of Pharmacy, Kyung Hee University 29:9-21.). Aster yomena, a perennial plant in the Asteraceae family, is abundant in resources, and recent research has shown that Aster yomena exhibits high physiological activity. Through recent scientific verification, various physiological activities of Aster yomena have been known, including antioxidant properties (Woo J H, Jeong H S, Yu J S, Chang Y D, Lee C H (2008), Antioxidant effect of extracts obtained from four aster species native to Korea, Plant Resources 21 (1): 52-59.), cancer prevention (Jung B M, Lim S S, Park Y J, Bae S J (2005), Inhibitory effects on cell survival and quinone reductase induced activity of Aster yomena fractions on human cancer cells, J Korean Soc Food Sci Nutr 34 (1): 8-12; Heo B G, Park Y S, Chon S U, Lee S Y, Cho J Y, Gorinstein S (2007), Antioxidant activity and cytotoxicity of methanol extracts from aerial parts of Korean salad plants. Biofactors 30 (2): 79-89.), and antibacterial activity (Chon S U, Kim D I, Choi Y S (2009), Assessments on insecticidal and fungicidal activities by aerial part extracts from several composite plants. Kor J Weed Sci 23 (2): 81-91.). Aster yomena is known to exhibit excellent antioxidant properties and contain chlorogenic acid and derivatives thereof, and phenolic compounds as components (Heo B G, Park Y S, Chon S U, Lee S Y, Cho J Y, Gorinstein S (2007) Antioxidant activity and cytotoxicity of methanol extracts from aerial parts of Korean salad plants. Biofactors 30 (2): 79-89; Nugroho A, Kim K H, Lee K R, Alam M B, Choi J S, Kim W B, Park H J (2009), Qualitative and quantitative determination of the caffeoylquinic acids on the Korean mountainous vegetables used for chwinamul and their peroxynitrite-scavenging effect. Archives of Pharmacal Research 32(10):1361-1367.). About 40 kinds of wild plants in Korea are cultivated as wild vegetables, but five major wild vegetables, which are bracken, Aster scaber Thunb., balloon flower, Pimpinella brachycarpa, Codonopsis lanceolata, and Aralia elata, account for 70% of the total cultivation area, indicating that the cultivation is concentrated on a small number of wild vegetables. As a result, Aster yomena has not been actively utilized or studied as a food product yet.

Meanwhile, Korean Patent No. 10-0747512, directed to a packaging method and a package of Korean pancake (buchimgae), discloses a Korean pancake packaging method, including: a Korean pancake batter manufacturing step in which one or a combination of kimchi, vegetables, and fish meat as main ingredients is cut into pieces to manufacture Korean pancake ingredients and a liquid Korean pancake batter is manufactured by one or a combination of rice powder, wheat flour, buckwheat powder, potato powder, and mung bean powder; and a freeze-molding packaging step in which the liquid Korean pancake batter is frozen and molded into a Korean pancake shape so that the shape of the Korean pancake is maintained during distribution and cooking is performed by unpacking and heating.

Korean Patent No. 10-2072395, directed to a dried dough composition for pollack kimchi Korean pancake and a method for producing the same, discloses a method for producing a dried dough composition for pollack kimchi Korean pancake, including the steps of: mixing vegetables, Korean pancake mix, pollack powder processed into powder after freeze-drying, and water in a container to manufacture a dough (S1); maturing the dough mixed in step S1 in a low-temperature maturing room (S2); putting the dough matured in step S2 into a mold and molding into a predetermined size (S3); putting the mold containing the matured dough into a freezer and rapidly freezing the dough (S4); and taking the frozen dough out of the freezer and sublimating it in a vacuum dryer to freeze-dry (S5).

Korean Patent No. 10-2066326, directed to a composition for a freeze-dried kimchi Korean pancake block and a freeze-dried kimchi Korean pancake block, discloses a freeze-dried kimchi Korean pancake block composition, including the steps of: preparing minor ingredients for kimchi Korean pancake; mixing the minor ingredients for kimchi Korean pancake and purified water with powdered pollack to manufacture a composition for a kimchi Korean pancake block; maturing the composition for kimchi Korean pancake block; and putting the matured composition for kimchi Korean pancake block into a mold and rapidly freeze-drying into a block shape.

Accordingly, the present invention sought to develop a Korean pancake mix composition of Korean pancake including Aster yomena that can be easily made and eaten at home.

### RELATED ART DOCUMENTS

### Patent Documents

Korean Patent No. 10-0747512 (published on Aug. 2, 2007)
Korean Patent No. 10-2072395 (published on Jan. 28, 2020)
Korean Patent No. 10-2066326 (published on Jan. 8, 2020)

### SUMMARY OF THE INVENTION

The present invention has been made to solve the above-described problems and to provide the necessary technology.

One object of the present invention is to provide a Korean pancake mix composition including Aster yomena and a manufacturing method thereof, and more specifically, a Korean pancake mix composition including Aster yomena and a manufacturing method thereof, wherein the Korean pancake mix composition is manufactured through a vegetable preprocessing step of preprocessing various vegetables including Aster yomena; a vegetable mixture packaging step of mixing and packaging vegetables; a wheat flour packaging step of packaging wheat flour; and a Korean pancake mix composition manufacturing step of packaging the vegetable mixture and wheat flour to manufacture a Korean pancake mix composition, so the Korean pancake mix composition including Aster yomena and a manufacturing method thereof have the advantages that excellent sensory preferences such as taste, aroma, and flavor due to the unique savory and bittersweet taste of Aster yomena are provided; and the vegetables are dried using near-infrared rays, so that the vegetables easily become soft without being soaked in water and the original color, taste, and aroma of raw vegetables may be preserved for a long time.

In addition, another object of the present invention is to provide a Korean pancake mix composition including Aster yomena and a manufacturing method thereof, wherein the composition and the method have the advantages that since vegetables and wheat flour are enclosed together, it is not necessary to individually manufacture each ingredient for the Korean pancake; and vegetables that are not in season may be consumed all year round, thereby providing economic benefits and convenience.

One embodiment of the present invention to achieve the above-described objects is described below.

One embodiment of the present invention provides A manufacturing method of a Korean pancake mix composition including Aster yomena, the method including: a vegetable preprocessing step of washing and cutting each of Aster yomena, zucchinis, carrots, green onions, chives, perilla leaves, and Cheongyang chili peppers, and drying them by irradiating near-infrared rays thereto; a vegetable mixture packaging step of inserting a vegetable mixture of Aster yomena, zucchinis, carrots, green onions, chives, perilla leaves, and Cheongyang chili peppers preprocessed in the vegetable preprocessing step into a packaging material and sealing and packaging the same; a wheat flour packaging step of inserting wheat flour into a packaging material and sealing and packaging the same, which is performed simultaneously with the vegetable mixture packaging step, or is performed before or after the vegetable mixture packaging step; and a Korean pancake mix composition manufacturing step of inserting the vegetable mixture packaged in the vegetable mixture packaging step and the wheat flour packaged in the wheat flour packaging step together into a packaging material and sealing the same to manufacture a Korean pancake mix composition.

At this time, in the vegetable preprocessing step, the near-infrared rays have a wavelength of 780 to 2500 nm.

At this time, in the vegetable preprocessing step, Aster yomena is washed and cut, and then dried at a temperature of 45 to 50° C. for 10 to 15 hours by irradiating near-infrared rays.

At this time, in the vegetable preprocessing step, the zucchinis are washed and cut, and then dried at a temperature of 43 to 48° C. for 13 to 18 hours by irradiating near-infrared rays thereto.

At this time, in the vegetable preprocessing step, the carrots are washed and cut, and then dried at a temperature of 45 to 50° C. for 13 to 18 hours by irradiating near-infrared rays thereto.

At this time, in the vegetable preprocessing step, the green onions are washed and cut, and then dried at a temperature of 43 to 48° C. for 13 to 18 hours by irradiating near-infrared rays thereto.

At this time, in the vegetable preprocessing step, the chives are washed and cut, and then dried at a temperature of 37 to 43° C. for 15 to 20 hours by irradiating near-infrared rays thereto.

At this time, in the vegetable preprocessing step, the perilla leaves are washed and cut, and then dried at a temperature of 43 to 48° C. for 10 to 15 hours by irradiating near-infrared rays thereto.

At this time, in the vegetable preprocessing step, the Cheongyang chili peppers are washed and cut, and then dried at a temperature of 43 to 48° C. for 13 to 18 hours by irradiating near-infrared rays thereto.

At this time, in the vegetable mixture packaging step, the vegetable mixture is composed by mixing Aster yomena at a proportion of 10% to 20% by weight, zucchinis at 33% to 43% by weight, carrots at 10% to 20% by weight, green onions at 4% to 10% by weight, chives at 4% to 10% by weight, perilla leaves at 4% to 10% by weight, and Cheongyang chili peppers at 4% to 10% by weight.

At this time, in the Korean pancake mix composition manufacturing step, the Korean pancake mix composition is packaged so as to consist of the vegetable mixture at a proportion of 3.5% to 13.5% by weight and the wheat flour at a proportion of 86.5% to 96.5% by weight.

Another embodiment of the present invention provides a Korean pancake mix composition including Aster yomena prepared by the above-described method.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a flowchart illustrating the individual process steps of the manufacturing method of a Korean pancake mix composition including Aster yomena according to one embodiment of the present invention; and

FIG. 2 shows a photograph of a Korean pancake mix composition including Aster yomena according to one embodiment of the present invention.

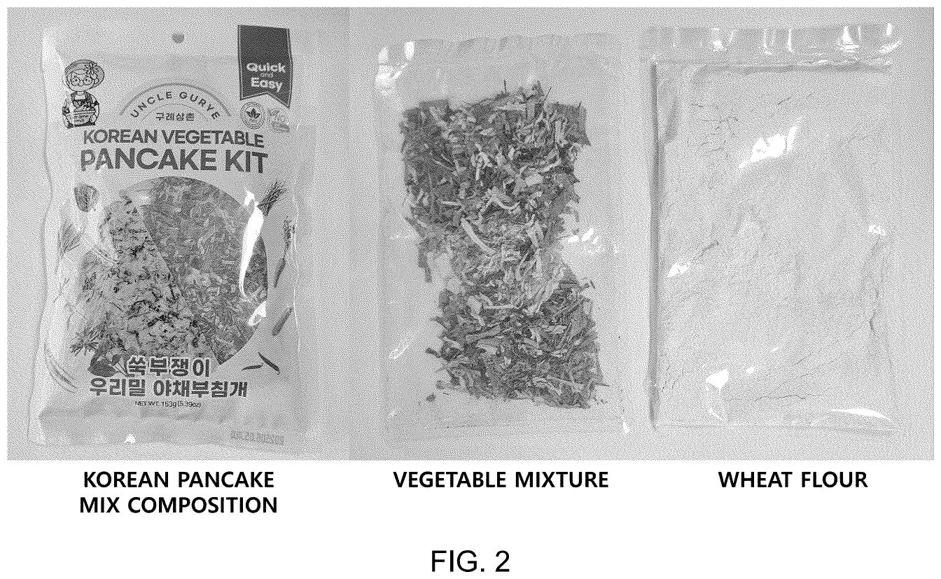

### DETAILED DESCRIPTION OF THE EMBODIMENTS

Hereinafter, embodiments of the present invention will be described in detail so that one of ordinary skill in the art to which the present invention pertains may easily implement. Embodiments of the present invention are provided to explain the present invention more completely to one of ordinary skill in the art. Therefore, embodiments of the present invention may be modified in various different forms, and the scope of the present invention is not limited to the embodiments described below.

Throughout the specification of the present invention, when a portion is said to “comprise” a certain component, it means that other components may be further included rather than excluding other components, unless otherwise specified.

Throughout the specification of the present invention, when a step is said to be located “on” or “before” another step, this may include the same rights as when a step has a direct time-series relationship with the other step, as well as when the two steps have an indirect time-series relationship where the time-series order may be changed, such as a mixing step after each step.

Throughout the specification of the present invention, the terms “about” or “substantially” are intended to have meanings close to numerical values or ranges specified with an allowable error and intended to prevent accurate or absolute numerical values disclosed for understanding of the present invention from being illegally or unfairly used by any unconscionable third party.

The present invention relates to a Korean pancake mix composition including Aster yomena and a manufacturing method of the same. The manufacturing method of a Korean pancake mix composition including Aster yomena according to the present invention includes a vegetable preprocessing step S100, a vegetable mixture packaging step S200, a wheat flour packaging step S300, and a Korean pancake mix composition manufacturing step S400.

Hereinafter, the manufacturing method of a Korean pancake mix composition including Aster yomena according to one embodiment of the present invention will be specifically described. The Korean pancake mix composition including Aster yomena according to one embodiment of the present invention (hereinafter also referred to as ‘Aster yomena Korean pancake mix composition’) may be more clearly understood through the manufacturing method described below.

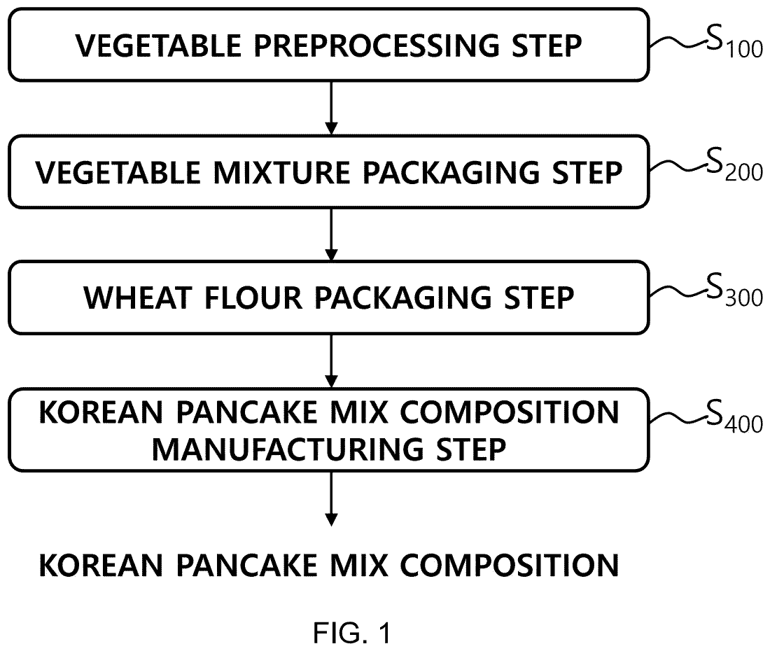

FIG. 1 shows a flowchart illustrating the individual process steps of the manufacturing method of a Korean pancake mix composition including Aster yomena according to one embodiment of the present invention.

First, a vegetable preprocessing step S100 is performed.

The vegetable preprocessing step S100, in which Aster yomena, zucchinis, carrots, green onions, chives, perilla leaves, and Cheongyang chili peppers are washed and cut, and then dried by irradiating near-infrared rays, is performed.

At this time, in the vegetable preprocessing step S100, the near-infrared rays have a wavelength of 780 to 2500 nm.

In addition, at this time, Aster yomena is washed and cut, and then dried at a temperature of 45 to 50° C. for 10 to 15 hours by irradiating near-infrared rays. The zucchinis are washed and cut, and then dried at a temperature of 43 to 48° C. for 13 to 18 hours by irradiating near-infrared rays thereto. The carrots are washed and cut, and then dried at a temperature of 45 to 50° C. for 13 to 18 hours by irradiating near-infrared rays thereto. The green onions are washed and cut, and then dried at a temperature of 43 to 48° C. for 13 to 18 hours by irradiating near-infrared rays thereto. The chives are washed and cut, and then dried at a temperature of 37 to 43° C. for 15 to 20 hours by irradiating near-infrared rays thereto. The perilla leaves are washed and cut, and then dried at a temperature of 43 to 48° C. for 10 to 15 hours by irradiating near-infrared rays thereto. The Cheongyang chili peppers are washed and cut, and then dried at a temperature of 43 to 48° C. for 13 to 18 hours by irradiating near-infrared rays thereto.

Near-infrared rays are emitted like bright visible light, and most of the energy penetrates the surface of an object and reaches the interior, heating the object to be dried and evaporating the moisture, thus drying it. This has the effect of maintaining the original ingredients or colors.

In the present invention, the near-infrared rays are used, and an appropriate drying temperature and drying time are set for each of Aster yomena, zucchinis, carrots, green onions, chives, perilla leaves, and Cheongyang chili peppers, so the vegetables are dried while maintaining the same taste, color, and flavor as the original vegetables. At this time, when the wavelength of the near-infrared rays is less than 780 nm, it is no different from drying in a natural state in the visible light range, so the drying takes a long time, and the color or taste of each vegetable may change as a result, and when the wavelength of the near-infrared rays exceeds 2500 nm, the drying time may be shortened due to the strong heat, but the color or nutrients of the vegetables may be damaged due to the excessive heat. In particular, vitamins that are sensitive to heat are easily destroyed, and the structure of the vegetables may change, which may cause a change in the taste.

In addition, along with near-infrared irradiation, the appropriate drying temperature and drying time are set in consideration of the components and structural characteristics of each vegetable, so that the nutrients, unique taste, color, aroma, flavor, and texture of the vegetables may be maintained as much as possible. With regard to the drying temperature and drying time, when drying is performed at a too low temperature or for a too short drying time without considering the characteristics of the vegetables, the drying may not be carried out properly and moisture may remain, which may cause a problem of reduced storability, and when drying is performed at a too high temperature or for a too long time, moisture may be excessively removed from the vegetables, which may cause problems such as breakage of the vegetable tissue, discoloration, deterioration of taste, and destruction of nutrients.

Therefore, in the vegetable preprocessing step S100, the near-infrared rays most preferably have a wavelength of 780 to 2500 nm. In addition, it is most preferable that Aster yomena is washed and cut, and then dried at a temperature of 45 to 50° C. for 10 to 15 hours by irradiating near-infrared rays thereto; the zucchinis are washed and cut, and dried at a temperature of 43 to 48° C. for 13 to 18 hours by irradiating near-infrared rays thereto; the carrots are washed and cut, and dried at a temperature of 45 to 50° C. for 13 to 18 hours by irradiating near-infrared rays thereto; the green onions are washed and cut, and dried at a temperature of 43 to 48° C. for 13 to 18 hours by irradiating near-infrared rays thereto; the chives are washed and cut, and dried at a temperature of 37 to 43° C. for 15 to 20 hours by irradiating near-infrared rays thereto; the perilla leaves are washed and cut, and dried at a temperature of 43 to 48° C. for 10 to 15 hours by irradiating near-infrared rays thereto; and the Cheongyang chili peppers are washed and cut, and dried at a temperature of 43 to 48° C. for 13 to 18 hours by irradiating near-infrared rays thereto.

Next, is a vegetable mixture packaging step performed.

The vegetable mixture packaging step S200 of inserting a vegetable mixture of Aster yomena, zucchinis, carrots, green onions, chives, perilla leaves, and Cheongyang chili peppers preprocessed in the vegetable preprocessing step S100 into a packaging material and sealing and packaging the same.

At this time, in the vegetable mixture packaging step S200, the vegetable mixture is composed by mixing Aster yomena at a proportion of 10% to 20% by weight, zucchinis at 33% to 43% by weight, carrots at 10% to 20% by weight, green onions at 4% to 10% by weight, chives at 4% to 10% by weight, perilla leaves at 4% to 10% by weight, and Cheongyang chili peppers at 4% to 10% by weight.

When Aster yomena is mixed in less than 10% by weight, there is a problem that the unique savory and bitter taste of Aster yomena is hardly felt due to the small amount, and when Aster yomena is mixed in more than 20% by weight, the taste of other vegetables is hardly felt due to the excessive amount, and the bitter taste increases, which may cause a problem that the taste of the Korean pancake is lowered. In addition, when zucchinis are mixed in an amount of less than 33% by weight or carrots are mixed in an amount of less than 10% by weight, the content of Aster yomena is relatively high, which also causes the taste of other vegetables to hardly be felt and the bitter taste may increase. When zucchinis are mixed in an amount of more than 43% by weight or carrots are mixed in an amount of more than 20% by weight, the content of Aster yomena is relatively low, which also causes the savory and bitter taste of Aster yomena to be hardly felt, and there is a problem that the unique greenish smell and sweetness that may come from zucchinis and carrots may be strongly felt. In addition, when the amount of condiment vegetables such as green onions, chives, perilla leaves, and Cheongyang chili peppers is less than 4% by weight, the savory and spicy flavors that may enrich the taste of the Korean pancake may be insufficient, and when the amount of condiment vegetables such as green onions, chives, perilla leaves, and Cheongyang chili peppers exceeds 10% by weight, the unique smell and spicy flavor of the condiment vegetables may become stronger, which may deteriorate sensory preferences.

Therefore, in the vegetable mixture packaging step S200, it is most preferable that a vegetable mixture composed by mixing Aster yomena at a proportion of 10% to 20% by weight, zucchinis at 33% to 43% by weight, carrots at 10% to 20% by weight, green onions at 4% to 10% by weight, chives at 4% to 10% by weight, perilla leaves at 4% to 10% by weight, and Cheongyang chili peppers at 4% to 10% by weight is inserted into a packaging material and sealed and packaged.

Next, a wheat flour packaging step S300 is performed.

The wheat flour packaging step S300 of inserting wheat flour into a packaging material and sealing and packaging the same, which is performed simultaneously with the vegetable mixture packaging step S200, or is performed before or after the vegetable mixture packaging step S200, is performed.

In the flour packaging step S300, the Korean pancake batter may be manufactured by mixing the vegetable mixture packaged in the vegetable mixture packaging step S200, and the flour is packaged separately from the vegetable mixture to improve the storability.

Next, a Korean pancake mix composition manufacturing step S400 is performed.

The Korean pancake mix composition manufacturing step S400 of inserting the vegetable mixture packaged in the vegetable mixture packaging step S200 and the wheat flour packaged in the wheat flour packaging step S300 together into a packaging material and sealing the same to manufacture a Korean pancake mix composition.

In the Korean pancake mix composition manufacturing step S400, the vegetable mixture package packaged in the vegetable mixture packaging step and the flour package packaged in the flour packaging step are inserted together into a separate packaging material, sealed, and repackaged to manufacture a Korean pancake mix composition.

At this time, in the Korean pancake mix composition manufacturing step S400, the Korean pancake mix composition is packaged so as to consist of the vegetable mixture at a proportion of 3.5% to 13.5% by weight and the wheat flour at a proportion of 86.5% to 96.5% by weight.

When the vegetable mixture is less than 3.5% by weight or the flour exceeds 96.5% by weight, the taste, aroma, and flavor of the vegetables are not easily felt due to the excessive amount of the flour and the small amount of the vegetable mixture, and only the flour taste is strongly felt, and when the Korean pancake is stir-fried, the vegetables are sparsely present, so the Korean pancake does not appear to be appetizing in terms of appearance. In addition, when the vegetable mixture exceeds 13.5% by weight or the flour is less than 86.5% by weight, the Korean pancake batter is not formed well due to the excessive amount of the vegetable mixture and the small amount of the flour, and when the Korean pancake is stir-fried, the shape is not well formed or it tears easily, so the Korean pancake does not appear to be appetizing in terms of appearance, and the problem may occur that the crispy texture may deteriorate due to the large amount of the vegetable mixture.

Therefore, while the vegetable mixture package packaged in the vegetable mixture packaging step S200 and the flour package packaged in the flour packaging step S300 are inserted together into a separate packaging material, sealed, and repackaged to manufacture a Korean pancake mix composition, it is most preferable that the Korean pancake mix composition is packaged so as to consist of the vegetable mixture at a proportion of 3.5% to 13.5% by weight and the wheat flour at a proportion of 86.5% to 96.5% by weight.

Hereinafter, a Korean pancake mix composition including Aster yomena was manufactured in various forms, and then a sensory test was conducted on the Korean pancake manufactured with the Korean pancake mix composition including Aster yomena. The Korean pancake mix composition including Aster yomena according to one embodiment of the present invention may be more clearly understood by the sensory test results described below.

### Example 1

### Sensory Test According to Process Conditions (Drying Method) of the Vegetable Preprocessing Step S100

The Aster yomena Korean pancake mix composition of the experimental group 1-1 was manufactured according to one embodiment of the present invention, and the Aster yomena Korean pancake mix compositions of the control groups 1-1 to 1-3 were manufactured by varying the vegetable drying method of the vegetable preprocessing step S100, and then Aster yomena Korean pancakes were manufactured with the Aster yomena Korean pancake mix compositions of the experimental group and the control groups, and a sensory test was performed according to the process conditions (drying method) of the vegetable preprocessing step S100.

### [Manufacture of Experimental Group and Control Groups of Example 1]

1. Vegetable preprocessing step S100: Aster yomena, zucchinis, carrots, green onions, chives, perilla leaves, and Cheongyang chili peppers were washed and cut, and then dried as shown in Table 1 below.

TABLE 1

| | Drying conditions | |
|---|---|---|
| Experimental | Near- | Near-infrared rays with a wavelength 780 |
| group 1-1 | infrared | to 2500 nm used |
| | drying | Aster yomena: dried at 48° C. for 13 hours |
| | | Zucchinis: dried at 45° C. for 15 hours |
| | | Carrots: dried at 48° C. for 15 hours |
| | | Green onions: dried at 45° C. for 15 hours |
| | | Chives: dried at 40° C. for 17 hours |
| | | Perilla leaves: dried at 45° C. for 12 hours |
| | | Cheongyang chili peppers: dried at 45° C. |
| | | for 15 hours |
| Control | Natural | Dried at room temperature (20 to 25° C.) |
| group 1-1 | drying | for three days |
| Control | Hot air | Dried with hot air at a temperature of |
| group 1-2 | drying | 55 to 65° C. for 24 hours |
| Control | Freeze | Frozen at −40 to −50° C. for 24 hours and |
| group 1-3 | drying | then dried at 40° C. for 24 hours |

2. Vegetable mixture packaging step S200: A vegetable mixture prepared by mixing 15.3% by weight of Aster yomena, 38.8% by weight of zucchinis, 15.3% by weight of carrots, 7.65% by weight of green onions, 7.65% by weight of chives, 7.65% by weight of perilla leaves, and 7.65% by weight of Cheongyang chili peppers was inserted into a packaging material and then sealed and packaged.

3. Wheat flour packaging step S300: In the wheat flour package step, which is performed simultaneously with the vegetable mixture packaging step, or is performed before or after the vegetable mixture packaging step, wheat flour was inserted into a packaging material and then sealed and packaged.

4. Korean pancake mix composition manufacturing step S400: The vegetable mixture packaged in the vegetable mixture packaging step and the wheat flour packaged in the wheat flour packaging step were inserted into the packaging material together and sealed to manufacture a Korean pancake mix composition, which was composed of 8.5% by weight of the vegetable mixture and 91.5% by weight of the wheat flour.

As shown in the above-described manufacturing method, the Aster yomena Korean pancake mix composition of the experimental group 1-1 was manufactured according to one embodiment of the present invention, and was manufactured after setting the drying conditions of the vegetables in the vegetable preprocessing step to be suitable for the conditions limited in the present invention.

In contrast, the Aster yomena Korean pancake mix compositions of control groups 1-1 to 1-3 were manufactured after setting the drying method differently from the drying method limited in the present invention.

### [Sensory Test for Experimental Group and Control Groups of Example 1]

A sensory test was performed on the Aster yomena Korean pancake manufactured with the Aster yomena Korean pancake mix composition of the experimental group 1-1 and the Aster yomena Korean pancakes manufactured with the Aster yomena Korean pancake mix compositions of the control groups 1-1 to 1-3.

The sensory test was performed by randomly selecting 50 adult male and female panelists aged between 20 and 60, and having the panelists taste the Aster yomena Korean pancakes manufactured with the Aster yomena Korean pancake mix compositions of the experimental group 1-1 and the control groups 1-1 to 1-3 and evaluate preferences such as taste, aroma, color, flavor, and texture using a 10-point scale evaluation method. The results of the average value of the sensory test performed with the 50 panelists are shown in Table 2 below.

TABLE 2

| | | | | | | Overall |
|---|---|---|---|---|---|---|
| Example 1 | Taste | Aroma | Color | Flavor | Texture | preference |
| Experimental | 9.5 | 9.4 | 9.5 | 9.5 | 9.6 | 9.5 |
| group 1-1 | | | | | | |
| Control | 7.5 | 7.4 | 7.2 | 7.3 | 6.9 | 7.3 |
| group 1-1 | | | | | | |
| Control | 8.2 | 8.1 | 7.8 | 7.6 | 7.4 | 7.8 |
| group 1-2 | | | | | | |
| Control | 9.1 | 9.0 | 8.2 | 9.0 | 7.8 | 8.6 |
| group 1-3 | | | | | | |

*Numerical values of the sensory test (10: Very good; 0: Very bad)

Table 2 shows the results of a sensory test for the Aster yomena Korean pancake mix composition of the experimental group 1-1 and the Aster yomena Korean pancake mix compositions of the control groups 1-1 to 1-3. The Aster yomena Korean pancake mix composition of the experimental group 1-1 manufactured according to one embodiment of the present invention was evaluated as having excellent preferences for all sensory test items such as taste, aroma, color, flavor, and texture.

In contrast, the control group 1-1, which was an Aster yomena Korean pancake mix composition manufactured by naturally drying Aster yomena, zucchinis, carrots, green onions, chives, perilla leaves, and Cheongyang chili peppers at room temperature in the vegetable preprocessing step, and the control group 1-2, which was an Aster yomena Korean pancake mix composition manufactured by hot-air drying Aster yomena, zucchinis, carrots, green onions, chives, perilla leaves, and Cheongyang chili peppers at a high temperature in the vegetable preprocessing step, exhibited discoloration of the vegetables and excessive moisture removal due to long-term drying or high-temperature drying, which caused the deterioration of the texture and the formation of a slightly chewy texture, and the unique smell from the dried vegetables was also exhibited. As a result, the evaluation showed that the consumer preferences for the taste, aroma, flavor, and texture were inferior to those of the experimental group.

In addition, the control group 1-3, which was an Aster yomena Korean pancake mix composition manufactured by freeze-drying Aster yomena, zucchinis, carrots, green onions, chives, perilla leaves, and Cheongyang chili peppers in the vegetable preprocessing step, was highly evaluated by consumers in terms of the taste, aroma, and flavor due to the advantage of freeze-drying that the original properties of the raw materials were maintained. However, the color and texture were evaluated low because that pancake was crumbled easily due to the porous structure and discoloration was caused by moisture absorption and oxidation.

Therefore, it was confirmed that in the vegetable preprocessing step S100 of the process for manufacturing the Aster yomena Korean pancake mix composition, when the near-infrared rays have a wavelength of 780 to 2500 nm, and at this time, when the drying conditions are specifically limited such that Aster yomena is washed and cut, and then dried at a temperature of 45 to 50° C. for 10 to 15 hours by irradiating near-infrared rays thereto; the zucchinis are washed and cut, and dried at a temperature of 43 to 48° C. for 13 to 18 hours by irradiating near-infrared rays thereto; the carrots are washed and cut, and dried at a temperature of 45 to 50° C. for 13 to 18 hours by irradiating near-infrared rays thereto; the green onions are washed and cut, and dried at a temperature of 43 to 48° C. for 13 to 18 hours by irradiating near-infrared rays thereto; the chives are washed and cut, and dried at a temperature of 37 to 43° C. for 15 to 20 hours by irradiating near-infrared rays thereto; the perilla leaves are washed and cut, and dried at a temperature of 43 to 48° C. for 10 to 15 hours by irradiating near-infrared rays thereto; and the Cheongyang chili peppers are washed and cut, and dried at a temperature of 43 to 48° C. for 13 to 18 hours by irradiating near-infrared rays thereto, the vegetable color of the finally manufactured Aster yomena Korean pancake mix composition remains vivid, the crispiness and softness are harmonized, and the savory taste is further amplified due to the addition of Aster yomena, thereby enhancing the preferences for the taste, aroma, color, flavor, and texture.

### Example 2

### Sensory Test According to Process Conditions (Vegetable Mixing Ratio) of the Vegetable Mixture Packaging Stage S200

The Aster yomena Korean pancake mix compositions of the experimental groups 2-1 to 2-3 were manufactured according to one embodiment of the present invention, and the Aster yomena Korean pancake mix compositions of the control groups 2-1 to 2-4 were manufactured by varying the vegetable mixing ratio in the vegetable mixture packaging step S200, and then Aster yomena Korean pancakes were made with the Aster yomena Korean pancake mix compositions of the experimental groups and the control group, and a sensory test was performed according to the process conditions (vegetable mixing ratio) of the vegetable mixture packaging step S200.

### [Manufacture of Experimental and Control Groups in Example 2]

1. Vegetable preprocessing step S100: The Aster yomena was washed and cut, and then dried at 48° C. for 13 hours by irradiating near-infrared rays with a wavelength of 780 to 2,500 nm. The zucchinis were washed and cut, and then dried at 45° C. for 15 hours by irradiating near-infrared rays with a wavelength of 780 to 2,500 nm. The carrots were washed and cut, and then dried at 48° C. for 15 hours by irradiating near-infrared rays with a wavelength of 780 to 2, 500 nm. The green onions were washed and cut, and then dried at 45° C. for 15 hours by irradiating near-infrared rays with a wavelength of 780 to 2, 500 nm. The chives are washed and cut, and then dried at 40° C. for 17 hours by irradiating near-infrared rays with a wavelength of 780 to 2, 500 nm. The perilla leaves were washed and cut, and dried at 45° C. for 12 hours by irradiating near-infrared rays with a wavelength of 780 to 2500 nm. The Cheongyang chili peppers were washed and cut, and dried at 45° C. for 15 hours by irradiating near-infrared rays of a wavelength of 780 to 2500 nm.

2. Vegetable mixture packaging step S200: A vegetable mixture prepared by mixing Aster yomena, zucchinis, carrots, green onions, chives, perilla leaves, and Cheongyang chili peppers was inserted into the packaging material and sealed and packaged. The mixing ratio of Aster yomena, zucchinis, carrots, green onions, chives, perilla leaves, and Cheongyang chili peppers is as shown in Table 3 below.

TABLE 3

| | | | | | | | Cheongyang |
|---|---|---|---|---|---|---|---|
| | | | | Green | | Perilla | chili |
| Unit: wt % | Aster yomena | Zucchinis | Carrots | onions | Chives | leaves | peppers |
| Experimental | 10 | 41.8 | 17.6 | 7.65 | 7.65 | 7.65 | 7.65 |
| group 2-1 | | | | | | | |
| Experimental | 15.3 | 38.8 | 15.3 | 7.65 | 7.65 | 7.65 | 7.65 |
| group 2-2 | | | | | | | |
| Experimental | 20 | 35.3 | 14.1 | 7.65 | 7.65 | 7.65 | 7.65 |
| group 2-3 | | | | | | | |
| Control | 0 | 48.8 | 20.6 | 7.65 | 7.65 | 7.65 | 7.65 |
| group 2-1 | | | | | | | |
| Control | 5 | 45.8 | 18.6 | 7.65 | 7.65 | 7.65 | 7.65 |
| group 2-2 | | | | | | | |
| Control | 25 | 31.8 | 12.6 | 7.65 | 7.65 | 7.65 | 7.65 |
| group 2-3 | | | | | | | |
| Control | 30 | 29.8 | 9.6 | 7.65 | 7.65 | 7.65 | 7.65 |
| group 2-4 | | | | | | | |

3. Wheat flour packaging step S300: In the wheat flour package step, which is performed simultaneously with the vegetable mixture packaging step, or is performed before or after the vegetable mixture packaging step, wheat flour was inserted into a packaging material and then sealed and packaged.

4. Korean pancake mix composition manufacturing step S400: The vegetable mixture packaged in the vegetable mixture packaging step and the wheat flour packaged in the wheat flour packaging step were inserted into the packaging material together and sealed to manufacture a Korean pancake mix composition, which was composed of 8.5% by weight of the vegetable mixture and 91.5% by weight of the wheat flour.

As shown in the above-described manufacturing method, the Aster yomena Korean pancake mix compositions of the experimental groups 2-1 to 2-3 were manufactured according to one embodiment of the present invention, and were manufactured after setting the vegetable mixing ratio in the vegetable preprocessing step S200 to be suitable for the conditions limited in the present invention.

In contrast, the Aster yomena Korean pancake mix compositions of the control groups 2-1 and 2-2 were manufactured after setting the process conditions so that Aster yomena was not added in the vegetable mixture packaging step S200 or the addition ratio of Aster yomena added in the vegetable mixture packaging step S200 was less than the addition ratio limited in the present invention, and as much as Aster yomena was not added or was added less, the zucchinis and carrots were mixed at addition ratios more than those limited in the present invention.

In addition, the Aster yomena Korean pancake mix compositions of the control groups 2-3 and 2-4 were manufactured after setting the process conditions so that the addition ratio of Aster yomena added in the vegetable mixture packaging step S200 was more than the addition ratio defined in the present invention, and as much as Aster yomena was added more, the zucchinis and carrots were mixed at addition ratios less than those limited in the present invention.

### [Sensory Test for Experimental Group and Control Groups of Example 2]

A sensory test was performed on the Aster yomena Korean pancake manufactured with the Aster yomena Korean pancake mix composition of the experimental groups 2-1 to 2-3 and the Aster yomena Korean pancakes manufactured with the Aster yomena Korean pancake mix compositions of the control groups 2-1 to 2-4.

The sensory test was performed by randomly selecting 50 adult male and female panelists aged between 20 and 60, and having the panelists taste the Aster yomena Korean pancakes manufactured with the Aster yomena Korean pancake mix compositions of the experimental groups 2-1 to 2-3 and the control groups 2-1 to 2-4 and evaluate preferences such as taste, aroma, color, flavor, and texture using a 10-point scale evaluation method. The results of the average value of the sensory test performed with the 50 panelists are shown in Table 4 below.

TABLE 4

| | | | | | | Overall |
|---|---|---|---|---|---|---|
| Example 2 | Taste | Aroma | Color | Flavor | Texture | preference |
| Experimental | 9.3 | 9.2 | 9.2 | 9.3 | 9.3 | 9.3 |
| group 2-1 | | | | | | |
| Experimental | 9.5 | 9.4 | 9.5 | 9.5 | 9.6 | 9.5 |
| group 2-2 | | | | | | |
| Experimental | 9.2 | 9.1 | 9.1 | 9.1 | 9.0 | 9.1 |
| group 2-3 | | | | | | |
| Control | 8.5 | 8.3 | 8.3 | 8.5 | 8.3 | 8.4 |
| group 2-1 | | | | | | |
| Control | 8.6 | 8.6 | 8.6 | 8.8 | 8.6 | 8.6 |
| group 2-2 | | | | | | |
| Control | 7.8 | 7.5 | 7.6 | 7.6 | 7.3 | 7.6 |
| group 2-3 | | | | | | |
| Control | 7.0 | 7.4 | 7.3 | 7.2 | 7.1 | 7.2 |
| group 2-4 | | | | | | |

*Numerical values of the sensory test (10: Very good; 0: Very bad)

Table 4 shows the results of the sensory test for the Aster yomena Korean pancake mix compositions of the experimental groups 2-1 to 2-3 and the Aster yomena Korean pancake mix compositions of the control groups 2-1 to 2-4. The Aster yomena Korean pancake mix compositions of the experimental groups 2-1 to 2-3 manufactured according to one embodiment of the present invention were evaluated as having excellent preferences for all sensory test items such as taste, aroma, color, flavor, and texture.

In contrast, the Aster yomena Korean pancake mix composition of the control group 2-1, which was manufactured after setting the process conditions so that Aster yomena was not added in the vegetable mixture packaging step S200 and the addition ratios of the zucchinis and carrots were higher than the addition ratios limited in the present invention, and the Aster yomena Korean pancake mix composition of the control group 2-2, which was manufactured after setting the process conditions so that the addition ratio of Aster yomena added in the vegetable mixture packaging step S200 was lower than the addition ratio limited in the present invention and the addition ratios of the zucchinis and carrots were higher than the addition ratio limited in the present invention, exhibited the taste of the general Korean pancakes, but due to the absence or small amount of Aster yomena added, the unique savory taste and bitter taste of Aster yomena, as well as the aroma and flavor, were hardly felt, and thus were evaluated as having insufficient consumer preferences for the taste, aroma, and flavor.

In addition, the Aster yomena Korean pancake mix compositions of the control groups 2-3 and 2-4, which were manufactured after setting the process conditions so that the addition ratio of Aster yomena was higher than the addition ratio limited in the present invention and the addition ratios of the zucchinis and carrots were lower than the addition ratios limited in the present invention in the vegetable mixture packaging step S200, were evaluated as having a strong bitter taste rather than a savory taste, due to the large amount of Aster yomena added, and thus exhibited a strong bittersweet taste and insufficient consumer preferences for taste, aroma, flavor, and texture due to the chewy texture.

Therefore, it was confirmed that in the vegetable mixture packaging step S200 during the manufacturing process of the Aster yomena Korean pancake mix composition, when the process conditions such as the vegetable mixing ratios are specifically limited such that Aster yomena is mixed at a proportion of 10% to 20% by weight, zucchinis at 33% to 43% by weight, carrots at 10% to 20% by weight, green onions at 4% to 10% by weight, chives at 4% to 10% by weight, perilla leaves at 4% to 10% by weight, and Cheongyang chili peppers at 4% to 10% by weight, the final Aster yomena Korean pancake mix composition is manufactured by mixing appropriately mixed vegetables and Aster yomena, thereby further enhancing the savory taste of the Korean pancake, and the unique bittersweet taste of Aster yomena enhances the preferences for the taste, aroma, color, flavor, and texture of the Korean pancake.

### Example 3

### Sensory Test According to Process Conditions (Mixing Ratio of Vegetable Mixture and Wheat Flour) in the Korean Pancake Mix Composition Manufacturing Stage S400

The Aster yomena Korean pancake mix compositions of the experimental groups 3-1 to 3-3 were manufactured according to one embodiment of the present invention, and the Aster yomena Korean pancake mix compositions of the control groups 3-1 to 3-4 were manufactured by varying the mixing ratio of the vegetable mixture and wheat flour in the Korean pancake mix composition manufacturing stage S400, and then the Aster yomena Korean pancakes were made with the Aster yomena Korean pancake mix compositions of the experimental groups and the control groups, and a sensory test was performed according to the process conditions (mixing ratio of vegetable mixture and wheat flour) in the Korean pancake mix composition manufacturing stage S400.

### [Manufacture of Experimental and Control Groups in Example 3]

1. Vegetable preprocessing step S100: The Aster yomena was washed and cut, and then dried at 48° C. for 13 hours by irradiating near-infrared rays with a wavelength of 780 to 2, 500 nm. The zucchinis were washed and cut, and then dried at 45° C. for 15 hours by irradiating near-infrared rays with a wavelength of 780 to 2, 500 nm. The carrots were washed and cut, and then dried at 48° C. for 15 hours by irradiating near-infrared rays with a wavelength of 780 to 2, 500 nm. The green onions were washed and cut, and then dried at 45° C. for 15 hours by irradiating near-infrared rays with a wavelength of 780 to 2, 500 nm. The chives are washed and cut, and then dried at 40° C. for 17 hours by irradiating near-infrared rays with a wavelength of 780 to 2, 500 nm. The perilla leaves were washed and cut, and dried at 45° C. for 12 hours by irradiating near-infrared rays with a wavelength of 780 to 2500 nm. The Cheongyang chili peppers were washed and cut, and dried at 45° C. for 15 hours by irradiating near-infrared rays of a wavelength of 780 to 2500 nm.

2. Vegetable mixture packaging step S200: A vegetable mixture prepared by mixing Aster yomena, zucchinis, carrots, green onions, chives, perilla leaves, and Cheongyang chili peppers was inserted into the packaging material and sealed and packaged. The mixing ratio of Aster yomena, zucchinis, carrots, green onions, chives, perilla leaves, and Cheongyang chili peppers is as shown in Table 3 below.

3. Wheat flour packaging step S300: In the wheat flour package step, which is performed simultaneously with the vegetable mixture packaging step, or is performed before or after the vegetable mixture packaging step, wheat flour was inserted into a packaging material and then sealed and packaged.

4. Korean pancake mix composition manufacturing step S400: The vegetable mixture packaged in the vegetable mixture packaging step and the wheat flour packaged in the wheat flour packaging step were inserted into the packaging material together and sealed to manufacture a Korean pancake mix composition, and the mixing ratio of the vegetable mixture and white flours are as shown in Table 5.

TABLE 5

| Unit: wt % | Vegetable mixture | White flour |
|---|---|---|
| Experimental group 3-1 | 5 | 95 |
| Experimental group 3-2 | 8.5 | 91.5 |
| Experimental group 3-3 | 10 | 90 |
| Control group 3-1 | 0 | 100 |
| Control group 3-2 | 3 | 97 |
| Control group 3-3 | 15 | 85 |
| Control group 3-4 | 20 | 80 |

As in the above-described manufacturing method, the Aster yomena Korean pancake mix compositions of the experimental groups 3-1 to 3-3 were manufactured according to one embodiment of the present invention after setting the mixing ratio of the vegetable mixture and the wheat flour in the Korean pancake mix composition manufacturing step S400 to be suitable for the conditions limited in the present invention. In contrast, the Aster yomena Korean pancake mix compositions of the control groups 3-1 and 3-2 were manufactured after setting the process conditions so that the vegetable mixture added in the Korean pancake mix composition manufacturing step S400 was not added or the vegetable mixture was mixed at a ratio less than the addition ratio limited in the present invention, and the wheat flour was mixed at a ratio more than the addition ratio limited in the present invention. In addition, the Aster yomena Korean pancake mix compositions of the control groups 3-3 and 3-4 were manufactured after setting the process conditions so that the vegetable mixture added in the Korean pancake mix composition manufacturing step S400 was mixed at ratio more than the addition ratio limited in the present invention, and the wheat flour was mixed at a ratio less than the addition ratio limited in the present invention.

### [Sensory Test for Experimental Group and Control Groups of Example 3]

A sensory test was performed on the Aster yomena Korean pancake manufactured with the Aster yomena Korean pancake mix composition of the experimental groups 3-1 to 3-3 and the Aster yomena Korean pancakes manufactured with the Aster yomena Korean pancake mix compositions of the control groups 3-1 to 3-4.

The sensory test was performed by randomly selecting 50 adult male and female panelists aged between 20 and 60, and having the panelists taste the Aster yomena Korean pancakes manufactured with the Aster yomena Korean pancake mix compositions of the experimental groups 3-1 to 3-3 and the control groups 3-1 to 3-4 and evaluate preferences such as taste, aroma, color, flavor, and texture using a 10-point scale evaluation method. The results of the average value of the sensory test performed with the 50 panelists are shown in Table 6 below.

TABLE 6

| | | | | | | Overall |
|---|---|---|---|---|---|---|
| Example 3 | Taste | Aroma | Color | Flavor | Texture | preference |
| Experimental | 8.8 | 8.8 | 8.6 | 8.7 | 8.7 | 8.7 |
| group 3-1 | | | | | | |
| Experimental | 9.3 | 9.3 | 9.3 | 9.2 | 9.4 | 9.3 |
| group 3-2 | | | | | | |
| Experimental | 9.2 | 9.2 | 9.0 | 9.1 | 9.1 | 9.1 |
| group 3-3 | | | | | | |
| Control | 6.5 | 6.5 | 6.2 | 6.4 | 6.0 | 6.3 |
| group 3-1 | | | | | | |
| Control | 6.5 | 6.5 | 6.7 | 6.5 | 6.8 | 6.6 |
| group 3-2 | | | | | | |
| Control | 7.5 | 7.7 | 7.8 | 7.5 | 7.4 | 7.6 |
| group 3-3 | | | | | | |
| Control | 7.2 | 7.5 | 7.6 | 7.4 | 7.1 | 7.4 |
| group 3-4 | | | | | | |

*Numerical values of the sensory test (10: Very good; 0: Very bad

Table 6 shows the results of the sensory test for the Aster yomena Korean pancake mix compositions of the experimental groups 3-1 to 3-3 and the Aster yomena Korean pancake mix compositions of the control groups 3-1 to 3-4. The Aster yomena Korean pancake mix compositions of the experimental groups 2-1 to 2-3 manufactured according to one embodiment of the present invention were evaluated as having excellent preferences for all sensory test items such as taste, aroma, color, flavor, and texture.

In contrast, the Aster yomena Korean pancake mix composition of the control group 3-1, which was manufactured after setting the process conditions so that the vegetable mixture added in the Korean pancake mix composition manufacturing step S400 was not added, and the Aster yomena Korean pancake mix composition of the control group 3-2, which was manufactured after setting the process conditions so that the vegetable mixture was mixed at a ratio less than the addition ratio limited in the present invention and the wheat flour was mixed at a ratio more than the addition ratio limited in the present invention, were evaluated as having a strong gritty taste due to the taste of the large amount of wheat flour, and only a slight chewiness was felt due to the small amount of vegetable mixture, and almost no taste, aroma, color, or flavor, and thus was felt, so the consumer preferences for taste, aroma, color, flavor, and texture were insufficient.

In addition, in the Korean pancake mix composition manufacturing step S400, the process conditions were set so that the vegetable mixture was mixed in a greater amount than the limited addition ratio in the present invention and the wheat flour was mixed in a less amount than the limited addition ratio in the present invention, and then the Aster yomena Korean pancake mix compositions of the control groups 3-3 and 3-4 were manufactured. Due to the large amount of vegetables, the crispiness was not felt well, and the texture was slightly chewy and the bitter and spicy tastes were strong, so the consumer preferences for taste, aroma, color, flavor, and texture were evaluated as insufficient.

Therefore, it was confirmed that in the Korean pancake mix composition manufacturing step S400 of the process for manufacturing the Aster yomena Korean pancake mix composition, when the process conditions, such as the mixing ratio of the vegetable mixture and wheat flour, are specifically limited such that the vegetable mixture is mixed at a proportion of 3.5% to 13.5% by weight and the wheat flour at a proportion of 86.5% to 96.5% by weight, the vegetable mixture and wheat flour are appropriately mixed in the Aster yomena Korean pancake mix composition, and the finally manufactured Aster yomena Korean pancake maintains the vegetable color vivid, and the crispiness and softness are harmonized, thereby enhancing the preferences for the taste, aroma, color, flavor, and texture.

In conclusion, through the results of the sensory tests on the Aster yomena Korean pancake mix compositions of Examples 1 to 3, it was confirmed that when the Aster yomena Korean pancake mix composition according to one embodiment of the present invention is manufactured by drying each of zucchinis, carrots, green onions, chives, perilla leaves, and Cheongyang chili peppers as well as Aster yomena by using near-infrared rays at appropriate temperatures for appropriate time, mixing them to prepare a vegetable mixture, and enclosing the resulting vegetable mixture with wheat flour, the Korean pancake made of the Korean pancake mix composition exhibits a soft texture without a particularly chewy or rough texture of the vegetables, as the vegetables are dried using near-infrared rays, and enhances the savory test due to Aster yomena, which is in harmony with the unique bittersweet taste of Aster yomena, thereby exhibiting excellent taste, aroma, color, flavor, and texture.

The Korean pancake mix composition including Aster yomena manufactured according to one embodiment of the present invention includes Aster yomena, and the Korean pancake mix composition is manufactured through a vegetable preprocessing step of preprocessing various vegetables including Aster yomena; a vegetable mixture packaging step of mixing and packaging vegetables; a wheat flour packaging step of packaging wheat flour; and a Korean pancake mix composition manufacturing step of packaging the vegetable mixture and wheat flour to manufacture a Korean pancake mix composition, so the Korean pancake mix composition including Aster yomena and a manufacturing method thereof have the advantages that excellent sensory preferences such as taste, aroma, and flavor due to the unique savory and bittersweet taste of Aster yomena are provided; and the vegetables are dried using near-infrared rays, so that the vegetables easily become soft without being soaked in water and the original color, taste, and aroma of raw vegetables may be preserved for a long time.

In addition, since vegetables and wheat flour are enclosed together, it is not necessary to individually manufacture each ingredient for the Korean pancake; and vegetables that are not in season may be consumed all year round, thereby providing economic benefits and convenience.

Although the present invention has been described in detail with reference to examples, the present invention is not limited to the above-described examples and may be modified in various forms, and it is obvious that many modifications are possible by those skilled in the art within the technical idea of the present invention. In addition, various substitutions, modifications, and changes are possible by those skilled in the art within the scope that does not depart from the technical idea of the present invention described in the claims, and these will also be considered to fall within the scope of the present invention.

What is claimed is:

1. A manufacturing method of a Korean pancake mix composition including Aster yomena, the method including:
a vegetable preprocessing step of washing and cutting each of Aster yomena, zucchinis, carrots, green onions, chives, perilla leaves, and Cheongyang chili peppers, and drying them by irradiating near-infrared rays thereto;
a vegetable mixture packaging step of inserting a vegetable mixture of Aster yomena, zucchinis, carrots, green onions, chives, perilla leaves, and Cheongyang chili peppers preprocessed in the vegetable preprocessing step into a packaging material and sealing and packaging the same;
a wheat flour packaging step of inserting wheat flour into a packaging material and sealing and packaging the same, which is performed simultaneously with the vegetable mixture packaging step, or is performed before or after the vegetable mixture packaging step; and
a Korean pancake mix composition manufacturing step of inserting the vegetable mixture packaged in the vegetable mixture packaging step and the wheat flour packaged in the wheat flour packaging step together into a packaging material and sealing the same to manufacture a Korean pancake mix composition.

2. The manufacturing method of a Korean pancake mix composition including Aster yomena according to claim 1, wherein, in the vegetable preprocessing step, the near-infrared rays have a wavelength of 780 to 2500 nm.

3. The manufacturing method of a Korean pancake mix composition including Aster yomena according to claim 1, wherein, in the vegetable preprocessing step, Aster yomena is washed and cut, and then dried at a temperature of 45 to 50° C. for 10 to 15 hours by irradiating near-infrared rays.

4. The manufacturing method of a Korean pancake mix composition including Aster yomena according to claim 1, wherein, in the vegetable preprocessing step, the zucchinis are washed and cut, and then dried at a temperature of 43 to 48° C. for 13 to 18 hours by irradiating near-infrared rays thereto.

5. The manufacturing method of a Korean pancake mix composition including Aster yomena according to claim 1, wherein, in the vegetable preprocessing step, the carrots are washed and cut, and then dried at a temperature of 45 to 50° C. for 13 to 18 hours by irradiating near-infrared rays thereto.

6. The manufacturing method of a Korean pancake mix composition including Aster yomena according to claim 1, wherein, in the vegetable preprocessing step, the green onions are washed and cut, and then dried at a temperature of 43 to 48° C. for 13 to 18 hours by irradiating near-infrared rays thereto.

7. The manufacturing method of a Korean pancake mix composition including Aster yomena according to claim 1, wherein, in the vegetable preprocessing step, the chives are washed and cut, and then dried at a temperature of 37 to 43° C. for 15 to 20 hours by irradiating near-infrared rays thereto.

8. The manufacturing method of a Korean pancake mix composition including Aster yomena according to claim 1, wherein, in the vegetable preprocessing step, the perilla leaves are washed and cut, and then dried at a temperature of 43 to 48° C. for 10 to 15 hours by irradiating near-infrared rays thereto.

9. The manufacturing method of a Korean pancake mix composition including Aster yomena according to claim 1, wherein, in the vegetable preprocessing step, the Cheongyang chili peppers are washed and cut, and then dried at a temperature of 43 to 48° C. for 13 to 18 hours by irradiating near-infrared rays thereto.

10. The manufacturing method of a Korean pancake mix composition including Aster yomena according to claim 1, wherein, in the vegetable mixture packaging step, the vegetable mixture is composed by mixing Aster yomena at a proportion of 10% to 20% by weight, zucchinis at 33% to 43% by weight, carrots at 10% to 20% by weight, green onions at 4% to 10% by weight, chives at 4% to 10% by weight, perilla leaves at 4% to 10% by weight, and Cheongyang chili peppers at 4% to 10% by weight.

11. The manufacturing method of a Korean pancake mix composition including Aster yomena according to claim 1, wherein, in the Korean pancake mix composition manufacturing step, the Korean pancake mix composition is packaged so as to consist of the vegetable mixture at a proportion of 3.5% to 13.5% by weight and the wheat flour at a proportion of 86.5% to 96.5% by weight.

12. A Korean pancake mix composition comprising Aster yomena prepared by the method of claim 1.
